(19) United States
(12) Patent Application Publication
(10) Pub. No.: US 2006/0274054 A1
(43) Pub. Date: Dec. 7, 2006

(54) Device for the manual entry and/or display of data

(75) Inventor: Gerhard Hochgesang, Bad Neustadt a.d. Saale (DE)

Correspondence Address: MCGRATH, GEISSLER, OLDS & RICHARDSON, PLLC, P.O. BOX 1364, FAIRFAX, VA, 22038-1364, US

(73) Assignee: Preh KeyTec GmbH

(21) Appl. No.: 11/445,294

(22) Filed: Jun. 2, 2006

(30) Foreign Application Priority Data
Jun. 2, 2005 (DE) DE102005025301.6

(51) Int. Cl. G09G 5/00

(52) U.S. Cl. 345/173

(57) ABSTRACT

The invention is directed to a device for the manual entry and/or display of data, comprised of a housing and a touch-sensitive display screen accommodated in the housing, said touch-sensitive screen being connected to a data processing unit that processes the entered data, whereby the display screen is movably integrated in the housing.

This nonprovisional application claims priority under 35 U.S.C. § 119(a) on German Patent Application No. DE 102005025301, which was filed in Germany on Jun. 2, 2005, and which is herein incorporated by reference.

### BACKGROUND OF THE INVENTION

1. Field of the Invention

The present invention relates to a device for manual entry and/or display of data, which includes a housing and a touch-sensitive display screen integrated in the housing, which is connected to a data processing unit that processes the entered data.

2. Description of the Background Art

Nowadays, entry of data, for example, numerical, alphanumerical, or product-specific data, is typically performed with keyboards or touch-sensitive display screens, typically-called touch screens. One sector, where data and products are frequently and recurrently entered into data processing devices, are cash registers in supermarkets or gas stations, for example. At these points of sale (POS), data entry is most frequently performed by using long-stroke keyboards or touch screens with resistively or capacitively operating surfaces. Also known are combinations of touch screens and keyboards. Touch screens are preferably employed where the product line is frequently changed, for example, or when products or sums with the associated merchandise are to be calculated and displayed right next to the input fields. It is hereby of benefit that changes or an adjustment of products or data can be done via the software without the need for manual intervention in the input systems.

To also utilize this benefit of a programmable display in the keyboard technology, it is known from the German utility patent DE 89 09 673 to integrate a touch screen in a keyboard. Disclosed is a display/keyboard unit for controlling devices having a display field and at least one key panel, whereby the display panel is a touch-sensitive touch screen that is integratable in the housing of the keyboard. In other words, by reprogramming, that is, by changing the software, the functions can be changed, or even expanded, at any time with such a display/keyboard unit, and can thus be adjusted to any desired circumstance.

Furthermore, it is known from DE 198 20 797 A1 to provide pressure keys with changeable displays. It is hereby possible, due to the controllable display units being integrated components of the keys, to reduce the number of necessary keys because, depending on the selected menu in the control unit, the pressure key can be provided with different displays. Also described therein is the use of a display unit as a liquid crystal display unit.

In actual application, however, the conventional and illustrated systems have substantial disadvantages. For example, the location and position of the systems cannot be adjusted to the fine motor skills of the operator, which limits the speed of the data entry. Furthermore, a characteristic of the touch-sensitive systems that are being used these days is the rigidity of stroke when operated. This rigid haptic of the operation process extremely reduces the input speed due to the absence of any haptic feedback to the operator so that the number of errors in the data entry is increased.

### SUMMARY OF THE INVENTION

It is therefore an object of the present invention to provide a device for the manual entry and/or display of data, which provides the operator with haptic feedback, thus eliminating the disadvantages of the conventional art. Furthermore, the device should be realizable with the simplest constructive means and cost-efficiently.

The objective of the invention is met such that a touch-sensitive display screen is movably integrated in a housing. By designing the device for data entry according to the present invention, it is now possible to provide the operator of a touch-sensitive display screen with haptics in the form of a traditional entry, corresponding to one the operator experiences when using a keyboard, for example. Now the operator need no longer visually confirm the entry on the display screen or directly on the touch screen, but he/she receives confirmation directly via the haptics of the moving display screen. One result is that the speed of the entry is significantly accelerated and the number of errors during entry is distinctly reduced. Depending on the number of product groups needed, or depending on the size of the housing, it is hereby feasible, of course, to integrate a plurality of touch-sensitive display screens in the housing.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a three-dimensional view of a long-stroke keyboard according to the conventional art;

FIG. 2 illustrates a key panel with an integrated touch-sensitive display screen, according to an embodiment of the present invention; and

FIG. 3 is a cross section of a key panel of the present invention corresponding to section III-III in FIG. 2.

### DETAILED DESCRIPTION

In FIG. 1, a three-dimensional view of a state-of-the-art long-stroke keyboard 1 is illustrated. The long-stroke keyboard includes a housing 2, in an upper front area of which a key panel 3 is arranged, and in a rear upper area of which an LCD display 4 is arranged. In addition, a key-operated switch 5 is integrated in the rear upper area of the housing. Between the front and rear upper area of the key panel, a key panel such as this can be equipped with, for example, a magnetic card reader 6. Above the key panel 3, four illuminated indicator displays 8 are provided in rim 7 of the key panel 3.

The keyboard 1 is activated, that is, voltage is applied via the key-operated switch 5. Depending on the mode of operation selected, different illuminated indicators 8 light up hereafter, which reflect the mode of operation or, as is common, indicate a change-over function in the keyboard 1, for example. It is known for the LCD display unit 4 to be indicator display unit 4 to provide an input confirmation to the operator, or to display selected menus or product groups. It is also known for such display units 4, which are integrated in the keyboard 1, to be touch-sensitive display screens.

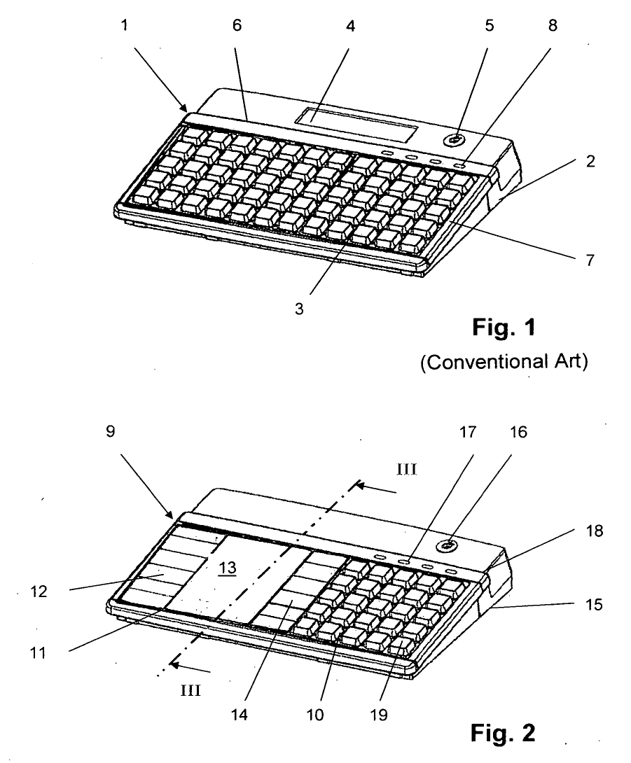

In FIG. 2, a keyboard 9 of basically similar construction is illustrated in a three-dimensional front view. In the front area of the key panel 10, an area, which is also used for data entry, is hereby formed of a touch-sensitive display screen 11. In this embodiment, the touch-sensitive display screen 11 is larger than the key panel 10. The touch-sensitive display screen 11, in turn, is hereby divided into different input fields 12, 13, 14. Such fields 12, 13, 14, are not strictly defined, but are generated by a software program, and can thus be assigned any desired functions. It is feasible, for example, to designate fields 12, 14, as input fields, and to utilize field 13 as an indicator field, which displays sums or products, for example. Furthermore, the construction of the keyboard of the present invention is substantially similar to the standard keyboard 1, as described in FIG. 1. Thus, a key-operated switch 16 is arranged in the upper rear area of housing 15. Likewise, the keyboard 9 includes a mode of operation indicator 17 and a magnetic card slider 18. It is hereby explicitly noted that the illustrated figures are merely exemplary embodiments. It is feasible in accordance with the present invention to integrate the touch-sensitive display screen 11 exclusively, that is, without a key panel, in the housing 15.

When data is entered via the touch-sensitive display screen 11, also called touch-screen 11, the touch screen 11 is able to move in the direction of the housing. Essentially, this movement is equal to a lift/drop of a key 19 of the key panel 10 and makes it possible for the operator to record the entry by haptic means. This is an essential benefit of the invention because the operator of the key panel 9 does not have to rely on the touch screen 11 for visual confirmation of the entry. Thus, an entry can be completed at a considerably faster speed and thus more economically. At the same time, errors in the data input can be reduced because the operator receives feedback that the data is entered.

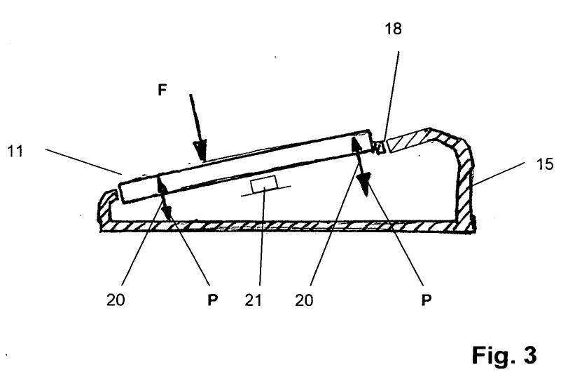

In FIG. 3, a cross section of FIG. 2 corresponding to view III-III is illustrated in principle. FIG. 3 shows a cross section of housing 15 and the location and arrangement of touch screen 11 in housing 15. In addition, the magnetic card slider 18 is shown.

In a preferred variation of an embodiment of the invention, the display screen is guided in housing 15 in a parallel guide 20. A parallel guide 20 such as this for the display screen 11 is known, for example, from DE 33 29 698, which corresponds to U.S. Pat. No. 4,580,022, and which is herein incorporated by reference. With a parallel guiding device, the display screen 11 is able to move parallel in the housing 15 in the direction of the arrows P, even in the event of an out-of-center contacting as illustrated with arrow F, due to the parallel guidances 20

Furthermore, in accordance with the invention, the parallel guiding means 20 makes it possible to arrange a switch element 21 in any desired position below the display screen 11, the switch element being contacted by the movement of the display screen 11, either indirectly or directly, via the parallel guide 20, or via guide elements in the parallel guide 20, for example.

If, however, the switching function is not needed, or in a mode of operation, the display screen merely serves as an indicator, it is conceivable according to the invention to block the movement of the display screen so the display screen is fixedly positioned in the housing 15. In this way, it is directly signaled to the operator that an entry is not possible at the present time, which simultaneously provides the operator with a haptic warning signal.

It is also feasible according to the present invention to accommodate a plurality of display screens 11 in housing 15, and to arrange them, also movably, in housing 15. This can be the case, for example, when the housing 15 makes a one-piece display screen 11 impossible due to its dimensions, or when completely different entries or positions of the entry are required in housing 15. It is hereby important that the display screens 11 have large surfaces or are of larger size, which can do more than merely display a limited selection of menus or various symbols, as is the case with known keyboard keys with LCD display. An additional benefit hereby is that the assignment of the display screen 11 is not fixed, but can be changed by software, or even long-distance by remote data maintenance.

The key panel 9 illustrated in FIG. 2, which is also referred to as keyboard 9, shows in its left front area the display screen 11, which is also referred to as keypad area and at the same time represents the touch module. This module provides the operator with the ability to display coherent text, receipts, information, prompts, as well as single keys with changeable size and text. The right area, which represents the key panel 10, includes the numerical block, which can be equipped with dedicatable keys as well as the release key. It goes without saying that it is also feasible in accordance with the present invention to provide the key panel 10 with pressure keys 19 having changeable displays.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A device for manual entry and/or display of data, the device comprising:
a housing; and
a touch-sensitive display screen movably integrated in the housing thereby providing a haptic response, the touch-sensitive display screen being connected to a processing unit that processes entered data.

2. The device according to claim 1, wherein the touch-sensitive display screen is guided in the housing by a parallel guide or a guiding device formed of double scissors.

3. The device according to claim 2, wherein the guiding device interacts with a switch element so that contact can be made with the switch element by a movement of the touch-sensitive display screen.

4. The device according to claim 1, wherein a movement of the display screen is limited by a guiding device.

5. The device according to claim 1, further comprising at least one key panel being included in the housing.

6. The device according to claim 5, wherein a movability of the touch-sensitive display screen corresponds to a lift/drop of a key of the key panel.

7. The device according to claim 1, wherein at least one magnetic card reader, at least one key-operated switch, at least one operating mode indicator, at least one smart card reader, and/or at least one finger printing system is included in the housing.
